(19) United States
(12) Patent Application Publication
(10) Pub. No.: US 2017/0137088 A1
(43) Pub. Date: May 18, 2017

(54) BICYCLE DRIVE UNIT

(71) Applicant: Shimano Inc., Osaka (JP)

(72) Inventor: Etsuyoshi WATARAI, Osaka (JP)

(21) Appl. No.: 15/240,683

(22) Filed: Aug. 18, 2016

(30) Foreign Application Priority Data
Nov. 16, 2015 (JP) 2015-223962

(51) Int. Cl. B62M 6/60; F16H 37/06; B62M 11/02

(52) U.S. Cl. CPC B62M 6/60; B62M 11/02; F16H 37/065

(57) ABSTRACT

A bicycle drive unit is provided that basically includes a planetary gear mechanism, a first motor and a worm drive. The planetary gear mechanism includes an input body, an output body and transmission body. The input body is configured to receive rotation from a crankshaft. The output body is configured to output rotation from the input body to outside of the bicycle drive unit. The transmission body is configured to control a rotation ratio of the input body to the output body. The first motor is configured to transmit rotation to the transmission body. The worm drive is provided in a transmission path that transmits rotation between the first motor and the transmission body.

### CROSS-REFERENCE TO RELATED APPLICATIONS

This application claims priority to Japanese Patent Application No. 2015-223962, filed on Nov. 16, 2015. The entire disclosure of Japanese Patent Application No. 2015-223962 is hereby incorporated herein by reference.

### BACKGROUND

Field of the Invention

The present invention generally relates to a bicycle drive unit.

Background Information

Some bicycles are provided with a bicycle drive unit to assist the rider by generating an auxiliary drive force. One example of such a bicycle drive unit is disclosed in PCT International Publication No. WO2013/160477 which comprises a first motor, a second motor, a pair of spur gears and a planetary gear mechanism. The spur gears are provided on the output shafts of the first and second motor, respectively. The planetary gear mechanism is connected to each of the first and second motors. In this drive unit, the gear ratio is maintained if the supply of power to the first motor is stopped.

### SUMMARY

Generally, the present disclosure is directed to various features of a bicycle drive unit. In one feature, a bicycle drive unit is provided with a planetary gear mechanism that is configured to change a rotational speed that is outputted by a crankshaft.

In the bicycle drive unit disclosed in PCT International Publication No. WO2013/160477, when a manual drive force is input to a crankshaft when the supply of power to the first motor is stopped, there is the risk that a portion of the planetary gear mechanism that is connected to the first motor will be operated in an undesired manner due to a reaction force thereof.

One object of the present invention is to provide a bicycle drive unit in which an undesired operation is not likely to occur in a portion of a planetary gear mechanism that is connected to a first motor.

In view of the state of the known technology and in accordance with a first aspect of the present disclosure, a bicycle drive unit according to the present invention comprises a planetary gear mechanism, a first motor and a worm drive. The planetary gear mechanism comprises an input body, an output body and a transmission body. The input body is configured to receive rotation of a crankshaft. The output body is configured to output rotation from the input body to outside of the bicycle drive unit. The transmission body is configured to control a rotation ratio of the input body to the output body. The first motor is configured to transmit rotation to the transmission body. The worm drive is provided in a transmission path of rotation between the first motor and the transmission body.

According to one example of the bicycle drive unit, the transmission body comprises a first gear that is a worm wheel that is engaged with a worm of the worm drive and that is provided on an output shaft of the first motor.

According to one example of the bicycle drive unit, the input body comprises a ring gear. The output body comprises a planetary gear engaged with the ring gear and a carrier that is coupled to the planetary gear. The transmission body comprises a sun gear engaged with the planetary gear.

According to one example of the bicycle drive unit, the input body comprises a planetary gear and a carrier that is coupled to the planetary gear. The output body comprises a ring gear engaged with the planetary gear. The transmission body comprises a sun gear engaged with the planetary gear.

According to one example of the bicycle drive unit, the transmission body further comprises a first gear that is a worm wheel that is engaged with a worm of the worm that is provided on an output shaft of the first motor, and the first gear and the sun gear are a single body.

One example of the bicycle drive unit further comprises a second motor configured to assist a manual drive force that is applied to the crankshaft.

According to one example of the bicycle drive unit, the input body comprises a second gear. The second motor has an output shaft with a spur gear engaged with the second gear.

According to one example of the bicycle drive unit, the input body further comprises a ring gear. The second gear and the ring gear are a single body. The output body comprises a planetary gear engaged with the ring gear and a carrier coupled to the planetary gear. The transmission body comprises a sun gear engaged with the planetary gear.

According to one example of the bicycle drive unit, the input body further comprises a planetary gear and a carrier that is coupled to the planetary gear. The second gear and the carrier are a single body.

According to one example of the bicycle drive unit, the output body comprises a third gear. The second motor has an output shaft with a spur gear engaged with the third gear.

According to one example of the bicycle drive unit, the input body comprises a ring gear. The output body further comprises a planetary gear engaged with the ring gear and a carrier coupled to the planetary gear. The third gear and the carrier are a single body.

According to one example of the bicycle drive unit, the input body comprises a planetary gear and a carrier that is coupled to the planetary gear. The transmission body comprises a sun gear engaged with the planetary gear. The output body further comprises a ring gear engaged with the planetary gear. The third gear and a ring gear are a single body.

According to one example of the bicycle drive unit, the output shaft of the first motor has a longitudinal center axis that is non-parallel to a longitudinal center axis of the output shaft of the second motor.

According to one example of the bicycle drive unit, the longitudinal center axis of the output shaft of the first motor and the longitudinal center axis of the output shaft of the second motor are perpendicular in a projection plane.

According to one example of the bicycle drive unit, the output shaft of the first motor has a longitudinal center axis, and the crankshaft has a longitudinal center axis that is perpendicular to the longitudinal center axis of the output shaft of the first motor in a projection plane when the bicycle drive unit is provided to the crankshaft.

According to one example of the bicycle drive unit, the transmission body is arranged to be disposed coaxially with the crankshaft when the bicycle drive unit is provided to the crankshaft.

According to one example of the bicycle drive unit, the worm is disposed in a different axial position from at least one of the input body and the output body with respect to an axial direction along a longitudinal center axis of the crankshaft when the bicycle drive unit is provided to the crankshaft.

According to one example of the bicycle drive unit, the worm drive has a worm that has a friction angle that is equal to or greater than a lead angle of the worm.

According to one example of the bicycle drive unit, the first motor is an inner rotor type motor.

One example of the bicycle drive unit further comprises an output unit that is coupled to the output body and the output unit being configured to be attached a front sprocket.

One example of the bicycle drive unit further comprises the crankshaft.

According to the bicycle drive unit, an undesired operation is not likely to occur in a portion of the planetary gear mechanism that is connected to the first motor.

### BRIEF DESCRIPTION OF THE DRAWINGS

Referring now to the attached drawings which form a part of this original disclosure.

FIG. 1 is a cross-sectional view of the bicycle drive unit of a first embodiment.

FIG. 2 is a schematic diagram showing the rotational direction of each component of the planetary gear mechanism of FIG. 1.

FIG. 3 is a perspective view of a part of the bicycle drive unit of FIG. 1.

FIG. 4 is a half cross-sectional view of the bicycle drive unit of a second embodiment.

FIG. 5 is a schematic diagram showing the rotational direction of each component of the planetary gear mechanism of FIG. 4.

FIG. 6 is a perspective view of a part of the bicycle drive unit of FIG. 4.

FIG. 7 is a schematic diagram of the bicycle drive unit of a first modified example.

FIG. 8 is a schematic diagram of the bicycle drive unit of a second modified example.

FIG. 9 is a schematic diagram of the bicycle drive unit of a third modified example.

FIG. 10 is a schematic diagram of the bicycle drive unit of a fourth modified example.

FIG. 11 s a schematic diagram of the bicycle drive unit of a fifth modified example.

### DETAILED DESCRIPTION OF EMBODIMENTS

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

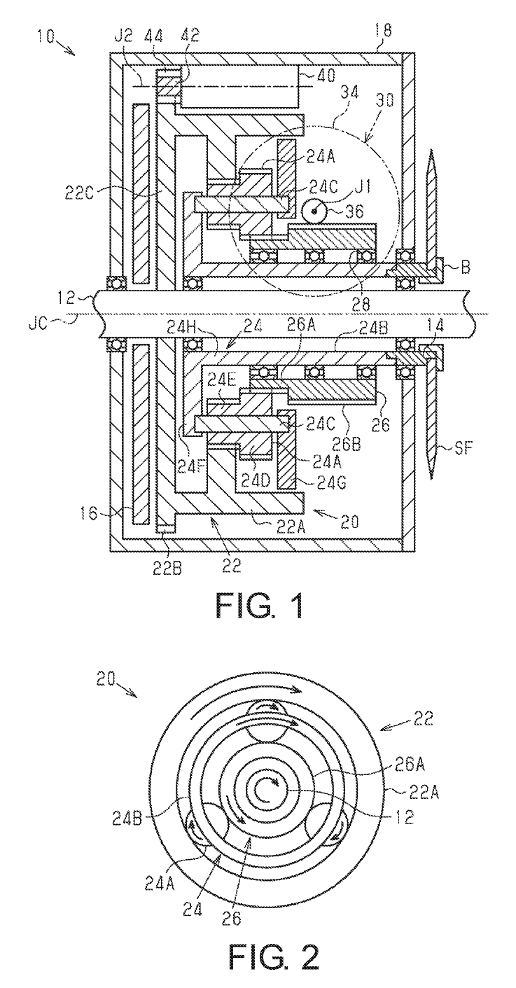

A bicycle drive unit 10 is shown in FIG. 1 (hereinafter referred to as “drive unit 10”) in accordance with a first embodiment. The bicycle drive unit 10 is provided on a frame (not shown) of a bicycle. The drive unit 10 is driven by power supplied from a battery (not shown) that is provided on the frame of the bicycle. The drive unit 10 has a function to assist in the travel of a bicycle by combining an assisting force with a manual drive force and a function of changing the gear ratio of the bicycle.

The drive unit 10 comprises a planetary gear mechanism 20, a first motor 30 and a worm 36 of a worm drive, discussed below. The drive unit 10 preferably further comprises a crankshaft 12, a second motor 40, an output unit 14, a controller 16 and a housing 18.

The housing 18 is provided with the crankshaft 12, the output unit 14, the controller 16, the planetary gear mechanism 20, the first motor 30, the worm 36 and the second motor 40. Both ends of the crankshaft 12 protrude from the housing 18. The housing 18 rotatably supports the crankshaft 12. The front sprocket SF is arranged on the side of the housing 18 and is coupled to the output unit 14. The output unit 14 transmits the rotation of the crankshaft 12 to the front sprocket SF.

The planetary gear mechanism 20 is configured to change the speed of rotation of the crankshaft 12 and output the same to outside of the drive unit 10. The planetary gear mechanism 20 comprises an input body 22, an output body 24 and a transmission body 26. The rotation of the crankshaft 12 is inputted to the input body 22. The output body 24 outputs the rotation that is transmitted to the input body 22 to outside of the drive unit 10. The transmission body 26 is configured to control the rotation ratio between the input body 22 and the output body 24. The input body 22 and the transmission body 26 are disposed coaxially with the crankshaft 12. The input body 22 is disposed coaxially with the transmission body 26. The output body 24 is coupled to the output unit 14.

The transmission body 26 comprises a sun gear 26A and a first gear 26B. Preferably, the transmission body 26 is a single body comprising the sun gear 26A and the first gear 26B. The sun gear 26A and the first gear 26B are formed in cylindrical shapes. The position in which the sun gear 26A is disposed is a position on the opposite side of the side with the front sprocket SF with respect to the first gear 26B in a direction along the axis JC of the crankshaft 12 (hereinafter referred to as “crankshaft direction”). The first gear 26B is a worm wheel that engages the worm 36 of the worm drive. The worm drive is formed by the first gear 26B (the worm wheel and the worm 36). A portion of the first gear 26B protrudes further on the side with the front sprocket SF than the input body 22. The outer diameter of the first gear 26B is larger than the outer diameter of the sun gear 26A. In another example, the sun gear 26A and the first gear 26B can be formed as separate parts, and the transmission body 26 can be formed by the two parts being coupled to each other. The outer diameter of the first gear 26B and the outer diameter of the sun gear 26A can be the same diameter. The sun gear 26A can be a spur gear or a helical gear. If the outer diameter of the first gear 26B and the outer diameter of the sun gear 26A are formed to be the same diameter, then the teeth of the sun gear 26A and the teeth of the first gear 26B can be formed so as to be continuous.

The input body 22 comprises a ring gear 22A and a second gear 22B. Preferably, the input body 22 is a single body comprising the ring gear 22A and the second gear 22B. The ring gear 22A and the second gear 22B are formed in cylindrical shapes. The input body 22 is coupled to the crankshaft 12. The input body 22 comprises a connecting portion 22C that is connected to the crankshaft 12. The connecting portion 22C is formed integrally with the ring gear A and the second gear 22B. The coupling structure between the input body 22 and the crankshaft 12 can take one of a plurality of forms. In a first embodiment, a spline provided on the outer peripheral surface of the crankshaft 12 and a spline provided on the inner peripheral surface of the input body 22 are fitted. In the second embodiment, the crankshaft 12 is press fitted into the peripheral surface of the input body 22. The second gear 22B is formed on an outer perimeter part of the input body 22. In another example, the ring gear 22A and the second gear 22B can be formed as separate parts, and the input body 22 can be formed by the two being coupled to each other. If the sun gear 26A is a spur gear, then the ring gear 22A and the planetary gear 24A are also formed of spur gears (as described below), and if the sun gear 26A is a helical gear, the ring gear 22A and the planetary gear 24A are also formed of helical gears.

The output body 24 comprises a plurality of planetary gears 24A, a carrier 24B and a plurality of planetary pins 24C. The planetary gears 24A engage the ring gear 22A and the sun gear 26A. The carrier 24B is coupled to the planetary gears 24A. The number of the planetary gears 24A is a matter that can be freely set as needed and/or desired. In the example shown in FIG. 2, the output body 24 comprises three of the planetary gears 24A, but the number of the planetary gears 24A can be one or more.

The planetary pins 24C are inserted into the planetary gears 24A and the carrier 24B to couple the planetary gears 24A and the carrier 24B. Both ends of the planetary pins 24C protrude from the planetary gears 24A in the crankshaft direction, and are supported by the carrier 24B. The supporting structure of the planetary gears 24A and the planetary pins 24C can take one of multiple forms. In a first embodiment, the planetary pins 24C are rotatable with respect to the carrier 24B, and the planetary gears 24A are non-rotatable with respect to the planetary pins 24C. In a second embodiment, the planetary pins 24C are non-rotatable with respect to the carrier 24B, and the planetary gears 24A are rotatable with respect to the planetary pins 24C. In a third embodiment, the planetary pins 24C are rotatable with respect to the carrier 24B, and the planetary gears 24A are rotatable with respect to the planetary pins 24C.

Each of the planetary gears 24A comprises a large gear 24D and a small gear 24E. The number of teeth of the large gear 24D is greater than the number of teeth of the small gear 24E. The large gear 24D engages the sun gear 26A. The small gear 24E engages the ring gear 22A. In another example each of the planetary gears 24A can comprise only one gear that engages the sun gear 26A and the ring gear 22A.

The carrier 24B is disposed coaxially with the crankshaft 12. The carrier 24B is rotated by each of the planetary gears 24A revolving around the sun gear 26A. The carrier 24B comprises a first carrier 24F and a second carrier 24G. The first carrier 24F and the second carrier 24G are separate parts. The carrier 24B is configured by the first carrier 24F and the second carrier 24G being fixed. In another example, the carrier 24B can be a single body comprising the first carrier 24F and the second carrier 24G.

The first carrier 24F supports one end of each of the planetary pins 24C. The second carrier 24G supports the other end of each of the planetary pins 24C. One end of the planetary pin 24C is disposed in a position that is farther from the front sprocket SF than the other end of the planetary pin 24C. The output body 24 comprises a connecting portion 24H. The shape of the connecting portion 24H is a cylindrical shape. The connecting portion 24H is connected to an inner perimeter part of the first carrier 24F. The position in which the connecting portion 24H is disposed is between the inner perimeter of the sun gear 26A and the outer perimeter of the crankshaft 12. The connecting portion 24H and the first carrier 24F can be integrally formed, or, be formed as separate bodies and coupled to each other.

The drive unit 10 further comprises a plurality of axle bearings 28 and a bolt B. The axle bearings 28 are disposed in positions that are between the outer perimeter of the connecting portion 24H and the inner perimeter of the transmission body 26. The connecting portion 24H supports the transmission body 26 via the axle bearings 28. The transmission body 26 is rotatable with respect to the connecting portion 24H. The output unit 14 is connected to the end of the connecting portion 24H. The output unit 14 is formed in a tubular shape, and is provided coaxially with the crankshaft 12. The front sprocket SF is coupled to the output unit 14 by, for example, a spline fitting. The output unit 14 is supported on the housing 18 via a bearing. The bolt B is screwed onto the end of the output unit 14 so as to sandwich the front sprocket SF between bolt B and the output unit 14. In this manner, the output unit 14 is coupled to the output body 24 and the front sprocket SF can be attached thereto. The output unit 14 can be integrally formed with the output body 24.

The first motor 30 and the second motor 40 are attached to the housing 18. The first motor 30 is configured to transmit rotation to the transmission body 26. The second motor 40 assists a manual drive force that is applied to the crankshaft 12. The first motor 30 and the second motor 40 are inner rotor type motors. In one example, the first motor 30 and the second motor 40 are three-phase brushless motors. The types and kinds of the first motor 30 and the second motor 40 can be freely changed as needed and/or desired. At least one of the first motor 30 and the second motor 40 can be an outer rotor type of motor as well.

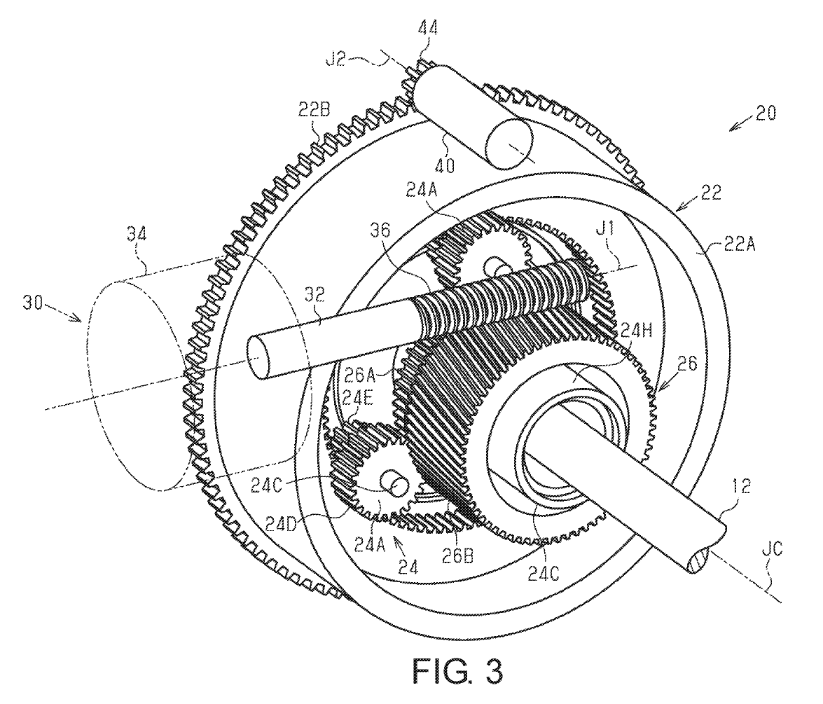

As shown in FIGS. 1 and 3, the direction along the axis J1 of the output shaft 32 of the first motor 30, and the direction along the axis JC of the crankshaft 12 are different from each other. Preferably, the direction along the axis J1 of the output shaft 32 of the first motor 30 and the direction along the axis JC of the crankshaft 12 are perpendicular in a projection plane. The direction along the axis J2 of the output shaft 42 of the second motor 40 and the direction along the axis JC of the crankshaft 12 are parallel. The direction along the axis J1 of the output shaft 32 of the first motor 30 and the direction along the axis J2 of the output shaft 42 of the second motor 40 are perpendicular in a projection plane. In this manner, the direction along the axis J1 of the output shaft 32 of the first motor 30 and the direction along the axis J2 of the output shaft 42 of the second motor 40 are different from each other. The relationships of these directions can be freely changed as needed and/or desired. It is not necessary for the direction along the axis J1 of the output shaft 32 of the first motor 30 and the direction along the axis J2 of the output shaft 42 of the second motor 40 to be perpendicular or to intersect in a projection plane.

The first motor 30 rotates the transmission body 26 via the worm 36. The first motor 30 changes the gear ratio of the planetary gear mechanism 20, which determines the gear ratio of the bicycle. The gear ratio of the planetary gear mechanism 20 is defined by the ratio of the rotational speed that is output from the planetary gear mechanism 20 relative to the rotational speed that is input to the planetary gear mechanism 20.

The worm 36 is provided in a transmission path of rotation between the first motor 30 and the transmission body 26. Preferably, the worm 36 is provided on the output shaft 32 of the first motor 30. As shown in FIG. 1, the worm 36 is disposed in a position that is different from the input body 22 in the crankshaft direction. In one example, the position in which the worm 36 is disposed in the crankshaft direction is a position that is further on the front sprocket SF side than the ring gear 22A, the second gear 22B, and the planetary gears 24A. The worm 36 is disposed in a position that is different from the second gear 22B in the radial direction of the crankshaft 12. In one example, the worm 36 is disposed inside of the second gear 22B and outside of the sun gear 26A in the radial direction of the crankshaft 12.

The friction angle of the worm 36 is equal to or greater than the lead angle (twist angle) of the worm 36. Accordingly, even if rotation is input to the first gear 26B, the first gear 26B does not rotate substantially, due to the engagement of the first gear 26B and the worm 36. The worm 36 and the output shaft 32 can be a single body, or the output shaft 32 and the worm 36 can be configured separately and be coupled by a joint or the like.

As shown in FIG. 3, the housing 34 of the first motor 30 is disposed further outside than the ring gear 22A in the radial direction of the crankshaft 12. The housing 34 is disposed in a position so that a portion thereof overlaps with the transmission body 26 and the output body 24 in a direction that is parallel to the axis J1 of the output shaft 32.

As shown in FIG. 1, the position in which the output shaft 42 of the second motor 40 is disposed is a position further away from the crankshaft 12 than the worm 36 in the radial direction. The drive unit 10 further comprises a spur gear 44. The spur gear 44 is provided on the output shaft 42 of the second motor 40. The spur gear 44 can be formed as a separate body from the output shaft 42 of the second motor 40 and be fixed to the output shaft 42, or can be the same body as the output shaft 42. The spur gear 44 engages the second gear 22B. The spur gear 44 and the second gear 22B transmit torque from the second motor 40 to the ring gear 22A.

The controller 16 is disposed in a position in the housing 18 on the opposite side from the front sprocket SF with respect to the crankshaft direction. The controller 16 comprises a circuit board having at least one processor, at least one memory device, a first drive circuit and a second drive circuit. The circuit board extends in a direction that is perpendicular to the axis JC of the crankshaft 12. The at least one processor and the at least one memory device are mounted on the circuit board. The first drive circuit is mounted on the circuit board and drives the first motor 30. The second drive circuit is mounted on the circuit board and drives the second motor 40. When the rotational direction of the crankshaft 12 is in a first rotational direction for moving the bicycle forward, the controller 16 drives the first motor 30 and the second motor 40 based on a travel condition of the bicycle. The controller 16 drives the second motor 40 by at least the second drive circuit based on a signal that is input from, for example, a torque sensor and a vehicle speed sensor (both not shown). The controller 16 drives the first motor 30 by the first drive circuit based on a signal that is input from an operating device (not shown) for changing the gear ratio of the bicycle. The controller 16 can drive the first motor 30 and the second motor 40 by the first drive circuit and the second drive circuit based on a signal that is input from at least one of, for example, a torque sensor, a vehicle speed sensor, and a crank rotation sensor (none shown). When the rotational direction of the crankshaft 12 is in a second rotational direction that is the opposite to the first rotational direction, the controller 16 stops the first motor 30 and the second motor 40.

When an operation signal for changing the gear ratio of the planetary gear mechanism 20 is inputted, the controller 16 controls the rotational speed of the first motor 30 so that the ratio of the rotational speed of the output unit 14 with respect to the rotational speed of the crankshaft 12 will be a prescribed ratio. For example, when an operation signal to increase the gear ratio of the planetary gear mechanism 20 is inputted, the controller 16 drives the first motor 30 so that the sun gear 26A is rotated in the second rotational direction (refer to FIG. 2). As a result, compared to when the sun gear 26A is not rotated, the rotational speed of the planetary gear 24A is increased. Therefore, the rotational speed of the carrier 24B is increased, and the gear ratio of the planetary gear mechanism 20 is increased. The controller 16 is programmed to change the gear ratio of the planetary gear mechanism 20 steplessly by changing the rotational speed of the sun gear 26A.

In another example, the controller 16 is programmed to change the gear ratio of the planetary gear mechanism 20 in a stepwise manner, by changing the rotational speed of the sun gear 26A in a stepwise manner. The number of steps of the gear ratio of the planetary gear mechanism 20 and the size of each gear ratio are set in advance. If an external device is connected to the controller 16 by wire or wirelessly, the external device is configured to change the number of steps of the gear ratio of the planetary gear mechanism 20 and the size of each gear ratio. Examples of an external device are a cycle computer or a personal computer.

After shifting the planetary gear mechanism 20 to a target gear ratio, the controller 16 stops the supply of power to the first motor 30. When the supply of power to the first motor 30 is stopped, the rotation of the transmission body 26 is limited due to the engagement of the worm 36 and the first gear 26B. Accordingly, the gear ratio of the planetary gear mechanism 20 is maintained at the target gear ratio based on the gear number of each component of the planetary gear mechanism 20.

When a signal corresponding to the manual drive force is input, the controller 16 is programmed to control the second motor 40 so that the ratio of the output torque of the second motor 40 with respect to the manual drive force will be a prescribed ratio. As a result, the torque of the second motor 40 is transmitted to the carrier 24B via the ring gear 22A. Then, this torque and torque that is input from the crankshaft 12 are combined and transmitted to the front sprocket SF via the output unit 14. When an operation signal for changing the assisting force is input, the controller 16 programmed to change the ratio of the output torque of the second motor 40 with respect to the torque due to the manual drive force and controls the second motor 40.

According to the first embodiment, the following actions and effects are obtained.

(1) The drive unit 10 comprises the worm 36 that is provided in a transmission path of rotation between the planetary gear mechanism 20 and the first motor 30. According to this configuration, when a manual drive force is input to the crankshaft 12, the rotation of the transmission body 26 is limited due to the engagement of the worm 36 and the first gear 26B. Accordingly, an undesired operation is not likely to occur in a portion of the planetary gear mechanism 20 that is connected to the first motor 30 when manual drive force is input to the crankshaft 12.

(2) The drive unit 10 comprises the spur gear 44 that is provided on the output shaft 42 of the second motor 40. According to this configuration, compared to a configuration in which a worm is provided to the output shaft 42 of the second motor 40, the transmission efficiency between the second motor 40 and the second gear 22B is increased.

(3) The friction angle of the worm 36 is equal to or greater than the lead angle of the worm 36. According to this configuration, an undesired operation is even less likely to occur in a portion of the planetary gear mechanism 20 that is connected to the first motor 30 when manual drive force is input to the crankshaft 12.

### Second Embodiment

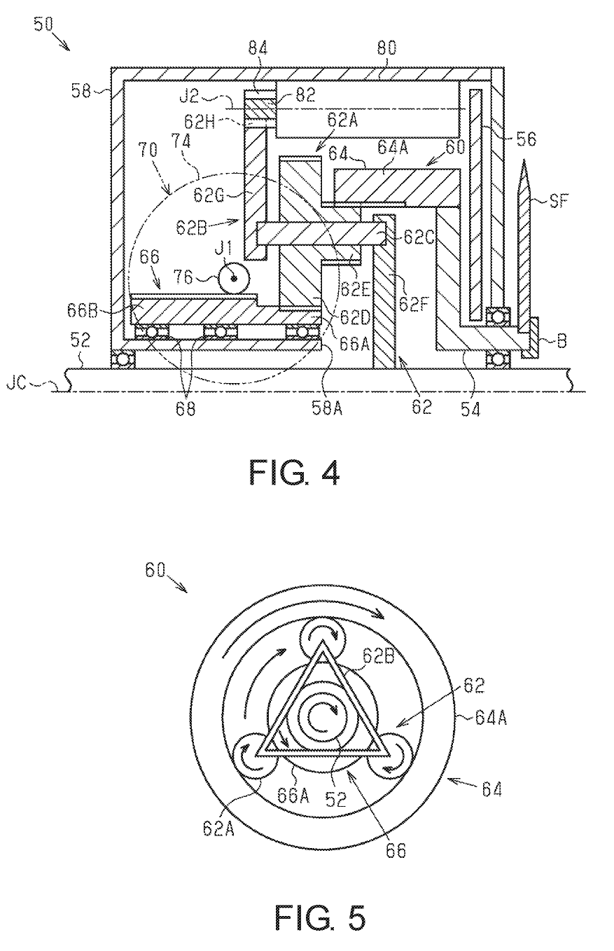

A drive unit 50 of a second embodiment will be described with reference to FIGS. 4 to 6.

As shown in FIG. 4, the drive unit 50 comprises a planetary gear mechanism 60, a first motor 70 and a worm 76. The drive unit 50 preferably further comprises a crankshaft 52, a second motor 80, an output unit 54, a controller 56 and a housing 58.

The housing 58 is provided with the crankshaft 52, the output unit 54, the controller 56, the planetary gear mechanism 60, the first motor 70, the worm 76, and the second motor 80. A support portion 58A is disposed coaxially with the crankshaft 52. The portion 58A is formed on the side opposite from the front sprocket SF in the housing 58 with respect to the crankshaft direction. The support portion 58A is formed in a cylindrical shape. The crankshaft 52 is inserted in the support portion 58A. The housing 58 rotatably supports the crankshaft 52. Both ends of the crankshaft 52 protrude from the housing 58 in the crankshaft direction. The front sprocket SF is arranged on the side of the housing 58, and is coupled to the output unit 54. The output unit 54 transmits the rotation of the crankshaft 52 to the front sprocket SF.

The planetary gear mechanism 60 changes the speed of the rotation of the crankshaft 52 and outputs the same to the outside. The planetary gear mechanism 60 comprises an input body 62, an output body 64, and a transmission body 66. The rotation of the crankshaft 52 is input to the input body 62. The output body 64 outputs the rotation to the outside. The transmission body 66 is configured to control the rotation ratio between the input body 62 and the output body 64. The output body 64 and the transmission body 66 are disposed coaxially with the crankshaft 52. The output body 64 is coupled to the output unit 54.

The transmission body 66 is rotatably supported on the support portion 58A by multiple axle bearings 68. The transmission body 66 can be rotatably supported on the crankshaft 52 as well. The transmission body 66 comprises a sun gear 66A and a first gear 66B. Preferably, the transmission body 66 is a single body comprising the sun gear 66A. and the first gear 66B. The sun gear 66A and the first gear 66B are formed in cylindrical shapes. The position in which the sun gear 66A is disposed is a position on the front sprocket SF side in the crankshaft direction with respect to the first gear 66B. The first gear 66B is disposed in a position on the side opposite of the front sprocket SF side in the crankshaft direction with respect to output body 64. The first gear 66B is a worm wheel that engages the worm 76. In another example, the sun gear 66A and the first gear 66B can be formed as separate bodies and the transmission body 26 can be formed by the two being coupled to each other. The outer diameter of the first gear 66B and the outer diameter of the sun gear 66A can be the same diameter. The sun gear 66A can be a spur gear or a helical gear. If the sun gear 66A is formed as a helical gear, the outer diameter of the first gear 66B and the outer diameter of the sun gear 66A can be the same diameter. and the teeth of the sun gear 66A and the teeth of the first gear 66B can be formed so as to be continuous.

The output body 64 comprises a ring gear 64A. An output unit 54 is coupled to an end of the ring gear 64A on the side with the front sprocket SF. The output unit 54 is formed in a tubular shape and is provided coaxially with the crankshaft 12. The output unit 54 is supported on the housing 58 via a bearing. The front sprocket SF is attached to the output unit 54 in the same manner as in the first embodiment. In this manner, the drive unit 50 further comprises an output unit 54 that is coupled to the output body 64 and to which can be attached the front sprocket SF. If the sun gear 66A is a spur gear, then the ring gear 64A and the planetary gear 62A are also spur gears, and if the sun gear 66A is a helical gear, then the ring gear 64A and the planetary gear 62A are also helical gears.

The input body 62 comprises a plurality of planetary gears 62A, a carrier 62B that is coupled to the planetary gear 62A and a plurality of planetary pins 62C. The planetary gears 62A engage the ring gear 64A and the sun gear 66A. The carrier 62B is coupled to the planetary gears 62A. The number of planetary gears 62A is a matter that can be freely set as needed and/or desired. In the example shown in FIG. 5, the input body 62 comprises three of the planetary gears 62A, but the number of the planetary gears 62A can be one or more.

The planetary pins 62C are inserted into the planetary gears 62A and the carrier 62B to couple the planetary gears 62A and the carrier 62B. Both ends of the planetary pins 62C protrude from the planetary gears 62A in the crankshaft direction, and are supported by the carrier 62B. The supporting structure of the planetary gears 62A and the planetary pins 62C can take one of several forms. In a first embodiment, the planetary pins 62C are rotatable with respect to the carrier 62B, and the planetary gears 62A are non-rotatable with respect to the planetary pins 62C. In a second embodiment, the planetary pins 62C are non-rotatable with respect to the carrier 62B, and the planetary gears 62A are rotatable with respect to the planetary pin 62C. In a third embodiment, the planetary pins 62C are rotatable with respect to the carrier 62B, and the planetary gears 62A are rotatable with respect to the planetary pins 62C.

Each of the planetary gears 62A comprises a large gear 62D and a small gear 62E. The number of teeth of the large gear 62D is greater than the number of teeth of the small gear 62E. The large gear 62D engages the sun gear 66A. The small gear 62E engages the ring gear 64A. In another example, each of the planetary gears 62A can comprise only one gear that engages the sun gear 66A and the ring gear 64A.

The carrier 62B is disposed coaxially with the crankshaft 52. The carrier 62B is rotated by each of the planetary gears 62A revolving around the sun gear 66A. The carrier 62B comprises a first carrier 62F and a second carrier 62G. The first carrier 62F and the second carrier 62G are separate parts. The carrier 62B is configured by the first carrier 62F and the second carrier 62G being fixed. In another example, the carrier 62B can be a single body comprising the first carrier 62F and the second carrier 62G.

The first carrier 62F supports one end of each of the planetary pins 62C. The second carrier 62G supports the other end of each of the planetary pins 62C. One of the ends of the planetary pins 62C is disposed in a position that is farther from the front sprocket SF than the other of the ends of the planetary pins 62C.

A second gear 62H is formed in the outer perimeter part of the second carrier 62G. That is, the input body 62 comprises a single body comprising the second carrier 62G and the second gear 62H. In another example, the second gear 62H and the second carrier 62G can be provided as separate parts, and the input body 62 can be formed by the two parts being coupled to each other.

The first motor 70 and the second motor 80 are attached to the housing 58. The first motor 70 is configured to transmit rotation to the transmission body 66. The second motor 80 assists a manual drive force that is applied to the crankshaft 52. The first motor 70 and the second motor 80 are inner rotor type motors. In one example, the first motor 70 and the second motor 80 are three-phase brushless motors. The type and kind of the first motor 70 and the second motor 80 can be freely changed as needed and/or desired. At least one of the first motor 70 and the second motor 80 can be an outer rotor type motor as well.

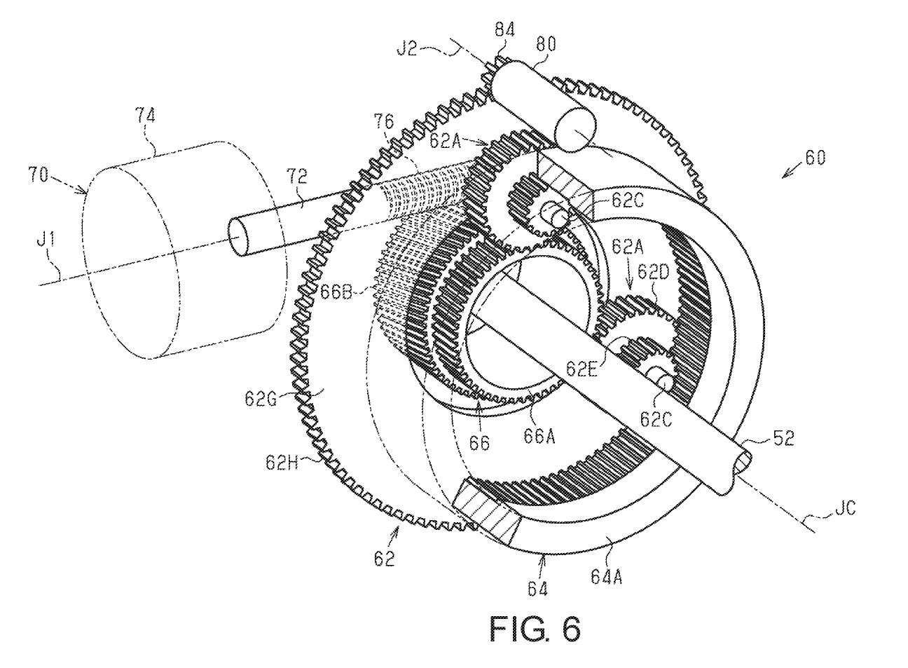

As shown in FIGS. 4 and 6, the direction along the axis J1 of the output shaft 72 of the first motor 70, and the direction along the axis JC of the crankshaft 52 are different from each other. Preferably, the direction along the axis J1 of the output shaft 72 of the first motor 70 and the direction along the axis JC of the crankshaft 52 are perpendicular in a projection plane. The direction along the axis J2 of the output shaft 82 of the second motor 80 and the direction along the axis JC of the crankshaft 52 are parallel. The direction along the axis J1 of the output shaft 72 of the first motor 70 and the direction along the axis J2 of the output shaft 82 of the second motor 80 are perpendicular in a projection plane. In this manner, the direction along the axis J1 of the output shaft 72 of the first motor 70 and the direction along the axis J2 of the output shaft 82 of the second motor 80 are different from each other. The relationships of these directions can be freely changed as needed and/or desired. It is not necessary for the direction along the axis II of the output shaft 72 of the first motor 70 and the direction along the axis J2 of the output shaft 82 of the second motor 80 to be perpendicular or to intersect in a projection plane.

The first motor 70 rotates the transmission body 66 via the worm 76. The first motor 70 changes the gear ratio of the planetary gear mechanism 60, which determines the gear ratio of the bicycle. The gear ratio of the planetary gear mechanism 60 is defined by the rotational speed that is output from the planetary gear mechanism 60 relative to the rotational speed that is input to the planetary gear mechanism 60.

The worm 76 is provided in a transmission path of rotation between the first motor 70 and the transmission body 66. Preferably, the worm 76 is provided on the output shaft 72 of the first motor 70. As shown in FIG. 4, the worm 76 is disposed in a position that is different from the input body 62 and the output body 64 in a direction along the crankshaft 52. In one example, the position in which the worm 76 is disposed in the crankshaft direction is a position that is further on the side opposite from the front sprocket SF than the ring gear 64A, the planetary gears 62A, the carrier 62B, and the second gear 62H. The worm 76 is disposed in a position that is different from the second gear 62H in the radial direction of the crankshaft 12. In one example, the worm 76 is disposed inside of the second gear 62H and outside of the sun gear 66A in the radial direction of the crankshaft 12.

The friction angle of the worm 76 is equal to or greater than the lead angle (twist angle) of the worm 76. Accordingly, even if the rotation of the first gear 66B is transmitted to the worm 76, the worm 76 does not rotate, due to the engagement of the first gear 66B and the worm 76. The worm 76 and the output shaft 72 can be a single body, or, the output shaft 72 and the worm 76 can be formed separately and be coupled by a joint or the like.

As shown in FIG. 6, the housing 74 of the first motor 70 is disposed outside the carrier 62B in the radial direction of the crankshaft 52. The housing 74 is disposed in a position so that a portion thereof overlaps with the transmission body 66 and the input body 62 in a direction that is parallel to the axis J1 of the output shaft 72.

As shown in FIG. 4, the position in which the output shaft 82 of the second motor 80 is disposed is a position further away from the crankshaft 52 than the worm 76 in the radial direction. The drive unit 50 further comprises a spur gear 84. The spur gear 84 is provided on the output shaft 82 of the second motor 80. The spur gear 84 can be formed as a separate body from the output shaft 82 of the second motor 80 and be fixed to the output shaft 82, or can be the same body as the output shaft 82. The spur gear 84 engages the second gear 62H. The spur gear 84 and the second gear 62H transmit torque from the second motor 80 to the carrier 62B.

The controller 56 is disposed in a position in the housing 58 further on the front sprocket SF side than the planetary gear mechanism 60, the first motor 70, and the second motor 80, in the crankshaft direction. The controller 56 has the same configuration and the same control programming as the controller 16 of the first embodiment, but in which the first motor 70 is controlled instead of the first motor 30, and the second motor 80 is controlled instead of the second motor 40.

The shifting operation of the drive unit 50 will be described with reference to FIGS. 4 and 5. The assisting operation of the drive unit 50 is the same as the assisting operation of the drive unit 10. In the schematic view of FIG. 5, the carrier 62B is shown by a triangular shape for the sake of convenience, but the actual shape of the carrier 62B is different, as shown in FIG. 6. The first rotational direction and the second rotational direction of the crankshaft 52 are the same as the first rotational direction and the second rotational direction of the crankshaft 12 of the first embodiment.

When an operation signal for changing the gear ratio of the planetary gear mechanism 60 is input, the controller 56 is programmed to control the rotational speed of the first motor 70 so that the ratio of the rotational speed of the output unit 54 with respect to the rotational speed of the crankshaft 52 will be a prescribed ratio. For example, when an operation signal to increase the gear ratio of the planetary gear mechanism 60 is input, the controller 56 operates the first motor 70 so that the sun gear 66A is rotated in the second rotational direction (refer to FIG. 5). As a result, as shown in FIG. 5, compared to when the sun gear 66A is not rotated, the rotational speed of the planetary gear 62A is increased; therefore, the rotational speed of the carrier 62B is increased, and the gear ratio of the planetary gear mechanism 60 is increased. The controller 56 programmed to change the gear ratio of the planetary gear mechanism 60 steplessly by changing the rotational speed of the sun gear 66A. In another example, the controller can change the gear ratio of the planetary gear mechanism 60 in a stepwise manner, by changing the rotational speed of the sun gear 66A in a stepwise manner.

After shifting the planetary gear mechanism 60 to a target gear ratio, the controller 56 programmed to stop the supply of power to the first motor 70. When the supply of power to the first motor 70 is stopped, the rotation of the transmission body 66 is limited due to the engagement of the worm 76 and the first gear 66B. Accordingly, the gear ratio of the planetary gear mechanism 60 is maintained at the target gear ratio based on the gear number of each component of the planetary gear mechanism 60. Since the carrier 62B configures the input body 62 and the ring gear 64A is coupled to the output unit 54, the planetary gear mechanism 60 accelerates the rotation that is input to the planetary gear mechanism 60 and outputs the same, when the sun gear 66A is not rotated. Accordingly, the gear ratio of the planetary gear mechanism 60 when the controller 56 stops the supply of power to the first motor 70 is “1” or more, for example, “1.2”. According to the second embodiment, the same effects as the first embodiment are obtained.

### Modifications

The descriptions relating to each embodiment described above are examples of forms that the bicycle drive unit according to the present invention can take, and are not intended to limit the forms thereof. The bicycle drive unit according to the present invention can take the forms of the modified examples of the above-described embodiments shown below, as well as forms that combine at least two modified examples that are not mutually contradictory. In FIGS. 8 to 11, the reference symbol of the drive unit 10 will be used for the sake of convenience.

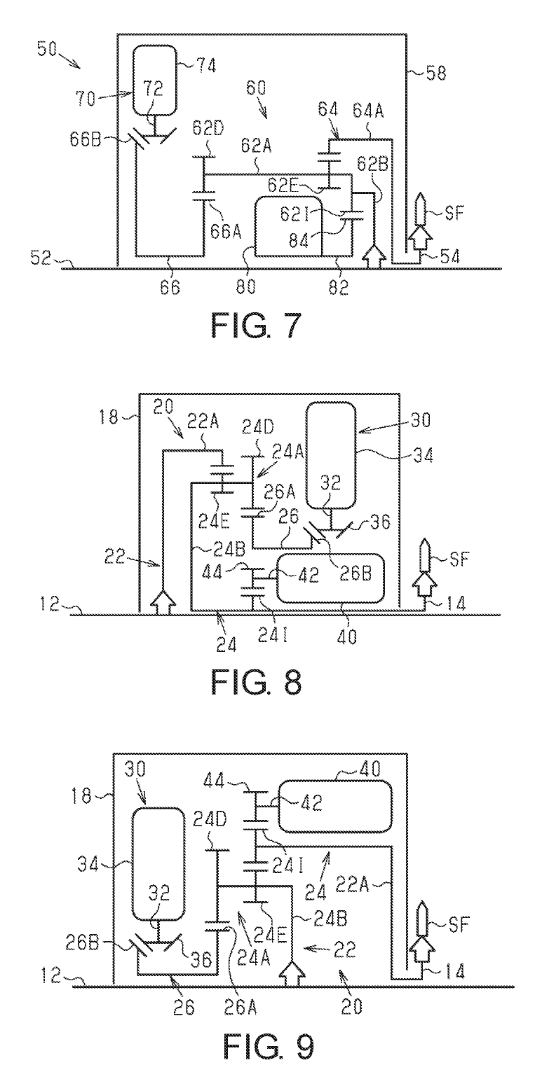

The position of the first motor 70 of the second embodiment can be freely changed as needed and/or desired. FIG. 7 shows one example thereof. In this example, the first motor 70 is disposed further outside the ring gear 64A in a direction that is perpendicular with the crankshaft direction.

The position of the second motor 80 of the second embodiment can be freely changed as needed and/or desired. FIG. 7 shows one example thereof. In this example, the second motor 80 is disposed coaxially with the crankshaft 52. The carrier 62B comprises inner peripheral teeth 62I. The inner peripheral teeth 62I mesh with spur gear 84 that is provided on the output shaft 82 of the second motor 80.

The configuration of the drive unit can be freely changed as needed and/or desired, as show in, for example, FIGS. 8 to 11. FIG. 8 shows a first example of a configuration of the drive unit. In the planetary gear mechanism 20 of the drive unit of FIG. 8, the input body 22 comprises the ring gear 22A, while the output body 24 comprises the planetary gears 24A, a carrier 24B and a third gear 24I. The transmission body 26 comprises the sun gear 26A and a first gear 26B. The third gear 24I and the carrier 24B are a single body. That is, the output body 24 comprises a single body comprising the third gear 24I and the carrier 24B. By such a configuration of the planetary gear mechanism 20, the rotation of the crankshaft 12 is input to the ring gear 22A, and the rotation of the carrier 24B is output to the front sprocket SF via the output unit 14. When the sun gear 26A is not rotated, the gear ratio of the planetary gear mechanism 20 is less than “1.” The first motor 30 is connected to the transmission body 26, and the second motor 40 is connected to the output body 24. The worm 36 is provided on the output shaft 32 of the first motor 30 and coupled to the first gear 26B. The spur gear 44 is provided on the output shaft 42 of the second motor 40 and engages the third gear 24I. Accordingly, the rotation of the first gear 26B is limited when the driving of the first motor 30 is stopped; therefore, even if torque is transmitted from the planetary gears 24A to the sun gear 26A, the sun gear 26A does not rotate. The gear ratio of the planetary gear mechanism 20 can be changed steplessly in accordance with the rotational speed of the first motor 30, by the first motor 30 driving the sun gear 26A to rotate in the second rotational direction.

In another example of the drive unit of FIG. 8, the carrier 24B and the third gear 24I are formed separately. When separately formed, the carrier 24B and third gear 24I form the output body 24 by being assembled to each other.

FIG. 9 shows a second example of a configuration of the drive unit. In the planetary gear mechanism 20 of the drive unit of FIG. 9, the input body 22 comprises at least one of the planetary gear 24A and the carrier 24B, while the output body 24 comprises the ring gear 22A and the third gear 24I. The transmission body 26 comprises the sun gear 26A and the first gear 26B. The third gear 24I and the ring gear 22A are a single body. That is, the output body 24 comprises a single body comprising the third gear 24I and the ring gear 22A. By such a configuration of the planetary gear mechanism 20, the rotation of the crankshaft 12 is input to the carrier 24B, and the rotation of the ring gear 22A is output to the front sprocket SF via the output unit 14. When the sun gear 26A is not rotated, the gear ratio of the planetary gear mechanism 20 is equal to or greater than “1,” The first motor 30 is connected to the transmission body 26, and the second motor 40 is connected to the output body 24. The worm 36 is provided on the output shaft 32 of the first motor 30 and coupled to the first gear 26B. The spur gear 44 is provided on the output shaft 42 of the second motor 40 and engages the third gear 24I. Accordingly, the rotation of the first gear 26B is limited when the driving of the first motor 30 is stopped; therefore, even if torque is transmitted from the planetary gear 24A to the sun gear 26A, the sun gear 26A does not rotate. The gear ratio of the planetary gear mechanism 20 can be changed steplessly in accordance with the rotational speed of the first motor 30, by the first motor 30 driving the sun gear 26A to rotate in the second rotational direction.

In another example of the drive unit of FIG. 9, the third gear 24I and the ring gear 22A are formed separately. When separately formed, the ring gear 22A and the third gear 24I form the output body 24 by being assembled to each other.

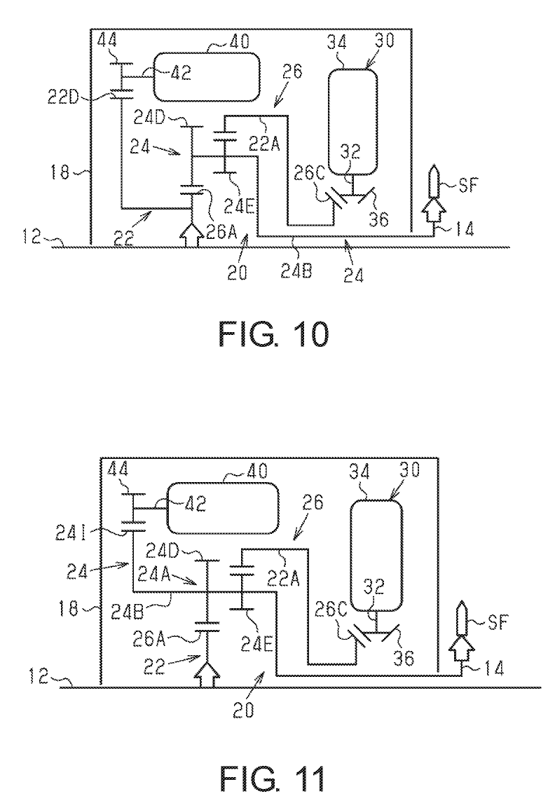

FIG. 10 shows a third example of a configuration of the drive unit. In the planetary gear mechanism 20 of the drive unit of FIG. 10, the input body 22 comprises the sun gear 26A and a second gear 22D, while the output body 24 comprises at least one of the planetary gears 24A and the carrier 24B. The transmission body 26 comprises the ring gear 22A and a first gear 26C. By this, the rotation of the crankshaft 12 is input to the sun gear 26A, and the rotation of the carrier 24B is output to the front sprocket SF via the output unit 14. When the ring gear 22A is not rotated, the gear ratio of the planetary gear mechanism 20 is less than “1.” The first motor 30 is connected to the transmission body 26, and the second motor 40 is connected to the input body 22. The worm 36 is provided on the output shaft 32 of the first motor 30 and coupled to the first gear 26C. The spur gear 44 is provided on the output shaft 42 of the second motor 40 and engages the second gear 22D. Accordingly, the rotation of the first gear 26C is limited when the driving of the first motor 30 is stopped; therefore, even if torque is transmitted from the planetary gear 24A to the ring gear 22A, the ring gear 22A does not rotate. The gear ratio of the planetary gear mechanism 20 can be changed steplessly in accordance with the rotational speed of the first motor 30, by the first motor 30 driving the ring gear 22A to rotate in the first rotational direction.

FIG. 11 shows a fourth example of a configuration of the drive unit. In the planetary gear mechanism 20 of the drive unit of FIG. 11, the input body 22 comprises the sun gear 26A, while the output body 24 comprises at least one of the planetary gears 24A, the carrier 24B and the third gear 24I. The transmission body 26 comprises the ring gear 22A and the first gear 26C. The third gear 24I and the carrier 24B are a single body. That is, the output body 24 comprises a single body comprising the third gear 24I and the carrier 24B. By such a configuration of the planetary gear mechanism 20, the rotation of the crankshaft 12 is input to the sun gear 26A, and the rotation of the carrier 24B is output to the front sprocket SF via the output unit 14. When the ring gear 22A is not rotated, the gear ratio of the planetary gear mechanism 20 is less than “1.” The first motor 30 is connected to the transmission body 26, and the second motor 40 is connected to the output body 24. The worm 36 is provided on the output shaft 32 of the first motor 30 and coupled to the first gear 26C. The spur gear 44 is provided on the output shaft 42 of the second motor 40 and engages the third gear 24I. Accordingly, the rotation of the first gear 26C is limited when the driving of the first motor 30 is stopped; therefore, even if torque is transmitted from the planetary gear 24A to the ring gear 22A, the ring gear 22A does not rotate. The gear ratio of the planetary gear mechanism 20 can be changed steplessly in accordance with the rotational speed of the first motor 30, by the first motor 30 driving the ring gear 22A to rotate in the first rotational direction.

In another example of the drive unit of FIG. 11, the third gear 24I and the carrier 24B are formed separately. When separately formed, the carrier 24B and third gear 24I form the output body 24 by being assembled to each other.

The gear shift mode of the first motor 30 of the first embodiment can be freely changed as needed and/or desired. In one example, the first motor 30 rotates the sun gear 26A in the first rotational direction. In this case, the gear ratio of the planetary gear mechanism 20 becomes smaller than the gear ratio of when the first motor 30 is stopped. The gear shift mode of the first motor 70 of the second embodiment can also be freely changed.

The positions of the first motor 30 and the second motor 40 of the first embodiment can be freely changed as needed and/or desired. In one example, at least one of the first motor 30 and the second motor 40 is provided outside of the housing 18. The positions of the first motor 70 and the second motor 80 of the second embodiment can also be freely changed as needed and/or desired.

The drive unit 10 of the first embodiment can take a form that does not comprise the second motor 40. In this case, the second gear 22B can be omitted from the drive unit 10. The drive unit 50 of the second embodiment can also be changed in the same way.

The drive unit 10 of the first embodiment can take a form that does not comprise the crankshaft 12. In this case, a crankshaft 12 as a component of the bicycle is provided to the drive unit 10. The drive unit 50 of the second embodiment can also be changed in the same way.

In the first embodiment, one or a plurality of gears can be provided in the transmission path between the output shaft 32 of the first motor 30 and the transmission body 26 besides the worm 36, in order to reduce the speed of the rotation of the output shaft 32 and to transmit the same to the input body 22. The drive unit 50 of the second embodiment can also be changed in the same way.

In the first embodiment, one or a plurality of gears can be provided between the output shaft 42 of the second motor 40 and the input body 22 or the output body 24, besides the spur gear 44, in order to reduce the speed of the rotation of the output shaft 42 and to transmit the same to the input body 22 or the output body 24. The drive unit 50 of the second embodiment can also be changed in the same way.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

Also it will be understood that although the terms “first” and “second” may be used herein to describe various components these components should not be limited by these terms. These terms are only used to distinguish one component from another. Thus, for example, a first component discussed above could be termed a second component and vice versa without departing from the teachings of the present invention. The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. A bicycle drive unit comprising:
a planetary gear mechanism comprising
an input body configured to receive rotation of a crankshaft,
an output body configured to output rotation from the input body to outside of the bicycle drive unit, and
a transmission body configured to control a rotation ratio of the input body to the output body;
a first motor configured to transmit rotation to the transmission body; and
a worm drive provided in a transmission path that transmits rotation between the first motor and the transmission body.

2. The bicycle drive unit according to claim 1, wherein
the transmission body comprises a first gear that is a worm wheel that is engaged with a worm of the worm drive and that is provided on an output shaft of the first motor.

3. The bicycle drive unit according to claim 1, wherein
the input body comprises a ring gear,
the output body comprises a planetary gear engaged with the ring gear and a carrier coupled to the planetary gear, and
the transmission body comprises a sun gear engaged with the planetary gear.

4. The bicycle drive unit according to claim 1, wherein
the input body comprises a planetary gear and a carrier that is coupled to the planetary gear,
the output body comprises a ring gear engaged with the planetary gear, and
the transmission body comprises a sun gear engaged with the planetary gear.

5. The bicycle drive unit according to claim 4, wherein
the transmission body further comprises a first gear that is a worm wheel that is engaged with a worm of the worm drive and that is provided on an output shaft of the first motor, and the first gear and the sun gear are a single body.

6. The bicycle drive unit according to claim 1, further comprising
a second motor configured to assist a manual drive force applied to the crankshaft.

7. The bicycle drive unit according to claim 6, wherein
the input body comprises a second gear, and
the second motor has an output shaft with a spur gear engaged with the second gear.

8. The bicycle drive unit according to claim 7, wherein
the input body further comprises a ring gear, and the second gear and the ring gear are a single body,
the output body comprises a planetary gear engaged with the ring gear and a carrier coupled to the planetary gear, and
the transmission body comprises a sun gear engaged with the planetary gear.

9. The bicycle drive unit according to claim 7, wherein
the input body further comprises a planetary gear and a carrier that is coupled to the planetary gear, and the second gear and the carrier are a single body,
the output body comprises a ring gear engaged with the planetary gear, and
the transmission body comprises a sun gear engaged with the planetary gear.

10. The bicycle drive unit according to claim 6, wherein
the output body comprises a third gear, and
the second motor has an output shaft with a spur gear engaged with the third gear.

11. The bicycle drive unit according to claim 10, wherein
the input body comprises a ring gear,
the output body further comprises a planetary gear engaged with the ring gear and a carrier coupled to the planetary gear, the third gear and the carrier are a single body, and
the transmission body comprises a sun gear engaged with the planetary gear.

12. The bicycle drive unit according to claim 10, wherein
the input body comprises a planetary gear and a carrier that is coupled to the planetary gear,
the transmission body comprises a sun gear engaged with the planetary gear, and
the output body further comprises a ring gear engaged with the planetary gear, and the third gear and a ring gear are a single body.

13. The bicycle drive unit according to claim 6, wherein
the output shaft of the first motor has a longitudinal center axis that is non-parallel to a longitudinal center axis of the output shaft of the second motor.

14. The bicycle drive unit according to claim 13, wherein
the longitudinal center axis of the output shaft of the first motor and the longitudinal center axis of the output shaft of the second motor are perpendicular in a projection plane.

15. The bicycle drive unit according to claim 1, wherein
the output shaft of the first motor has a longitudinal center axis, and the crankshaft has a longitudinal center axis that is perpendicular to the longitudinal center axis of the output shaft of the first motor in a projection plane when the bicycle drive unit is provided to the crankshaft.

16. The bicycle drive unit according to claim 1, wherein
the transmission body is arranged to be disposed coaxially with the crankshaft when the bicycle drive unit is provided to the crankshaft.

17. The bicycle drive unit according to claim 1, wherein
the worm drive is disposed in a different axial position from at least one of the input body and the output body with respect to an axial direction along a longitudinal center axis of the crankshaft when the bicycle drive unit is provided to the crankshaft.

18. The bicycle drive unit according to claim 1, wherein
the worm drive has a worm that has a friction angle that is equal to or greater than a lead angle of the worm.

19. The bicycle drive unit according to claim 1, wherein
the first motor is an inner rotor type motor.

20. The bicycle drive unit according to claim 1, further comprising
an output unit coupled to the output body, and the output unit being configured to be attached a front sprocket.

21. The bicycle drive unit according to claim 1, further comprising the crankshaft.
